(19) United States
(12) Patent Application Publication
(10) Pub. No.: US 2011/0043964 A1
(43) Pub. Date: Feb. 24, 2011

(54) CERAMIC POWDER COMPOSITION, CERAMIC MATERIAL, AND MULTI-LAYER CERAMIC CAPACITOR FABRICATED THEREBY

(75) Inventors: I-LUN HUANG, Taipei County (TW); Ting-An Chien, Tainan County (TW); Hsiu-Hsiang Pei, Taipei County (TW); Chao-Kuang Hsiao, Tainan City (TW); Kuan-Zong Fung, Taipei City (TW); Chih-Cheng Chen, Taoyuan County (TW)

Correspondence Address: WPAT, PC, Suite 200, 1940 Duke Street, Alexandria, VA, 22314, US

(73) Assignee: Darfon Electronics Corp., Taoyuan (TW)

(21) Appl. No.: 12/860,100

(22) Filed: Aug. 20, 2010

(30) Foreign Application Priority Data
Aug. 21, 2009 (TW) 098128146

(51) Int. Cl. H01G 4/06; C04B 35/475

(52) U.S. Cl. 361/321.4; 501/139; 501/138

(57) ABSTRACT

A ceramic powder composition, ceramic material, and a multi-layer ceramic capacitor fabricated thereby are provided. The ceramic powder composition includes a main ingredient and an accessory ingredient. The main ingredient is in an amount of 95 to 99 mol %, and includes BaTiO₃, and the accessory ingredient is in an amount of 1 to 5 mol %, and consists of oxide Bi₂O₃—Tio₂—XO, where X is selected from a group consisting of magnesium (Mg), vanadium (V), manganese (Mn), and chromium (Cr).

### BACKGROUND OF THE INVENTION

1. Field of Invention

The present invention relates to a ceramic powder composition, a ceramic material, and a multi-layer ceramic capacitor fabricated thereby, and more particularly to a ceramic powder composition, a ceramic material, and a multi-layer ceramic capacitor fabricated thereby that meet the X8S temperature range.

2. Related Art

In recent years, as electronic elements develop towards small, chip-based, multi-functional, and high-capacity designs, various integration technologies attract much attention. Similarly, as for capacitors, besides the thin and small and multi-layer design of elements is inevitable, requirements for design of dielectric materials with high capacitance and micro-grain structure become increasingly strict. Therefore, ceramic capacitors also develop in the trend of achieving maximum functions in a minimum volume.

Applications of commercial ceramic capacitors are largely classified into Y5V, X5R, X7R, and X8S specifications, and the specification required by X8S basically refers to a relative capacitance variation of ±22% over a temperature range of −55° C. to 150° C.

### SUMMARY OF THE INVENTION

The present invention is directed to a ceramic powder composition, which meets the X8S temperature range.

The present invention is directed to a ceramic material, which meets the X8S temperature range.

The present invention is directed to a multi-layer ceramic capacitor, which meets the X8S temperature range.

The present invention provides a ceramic powder composition, which comprises a main ingredient and an accessory ingredient. The main ingredient is in an amount of 95 to 99 mol % and comprises BaTiO₃. The accessory ingredient is in an amount of 1 to 5 mol % and consists of oxide Bi₂O₃—TiO₂—XO, where X is selected from a group consisting of magnesium (Mg), vanadium (V), manganese (Mn), and chromium (Cr).

The present invention further provides a ceramic material, which is formed by sintering the ceramic powder composition.

The present invention further provides a multi-layer ceramic capacitor, which comprises a ceramic dielectric, a plurality of internal electrodes, and at least one external electrode. The ceramic dielectric is formed by sintering the ceramic powder composition. The internal electrodes substantially extend in parallel in the ceramic dielectric. The external electrode is exposed out of the ceramic dielectric, and is electrically connected to the internal electrodes.

In summary, by using a main ingredient including BaTiO₃ in combination with an accessory ingredient consisting of oxide Bi₂O₃—TiO₂—XO, the present invention provides a ceramic powder composition, a ceramic material, and a multi-layer ceramic capacitor fabricated thereby that meet the X8S temperature range.

### BRIEF DESCRIPTION OF THE DRAWINGS

The present invention will become more fully understood from the detailed description given herein below for illustration only, and thus are not limitative of the present invention, and wherein:

FIG. 1 is a ternary phase diagram of oxide Bi₂O₃—TiO₂—XO;

FIG. 2 shows a formation area range of the oxide Bi₂O₃—TiO₂—XO meeting the X8S temperature range;

FIG. 3 is a relation diagram of capacitance variation of multi-layer ceramic capacitors and temperature; and

FIG. 4 is a sectional structural view of a multi-layer ceramic capacitor.

### DETAILED DESCRIPTION OF THE INVENTION

The ceramic powder composition of the present invention is described below through preferred embodiments with reference to the accompanying drawings. For ease of understanding, the same reference numbers are used to refer to the same parts in the embodiments.

The ceramic powder composition of the present invention is formed by combining and sintering a main ingredient and an accessory ingredient at a particular ratio. The main ingredient includes BaTiO₃, and the accessory ingredient consists of oxide Bi₂O₃—TiO₂—XO, where X is selected from a group consisting of magnesium (Mg), vanadium (V), manganese (Mn), and chromium (Cr). The main ingredient is in an amount of 95 to 99 mol %, and the accessory ingredient is in an amount of 1 to 5 mol %. After sintering the main ingredient and the accessory ingredient at the ratio, a ceramic powder composition meeting the X8S temperature range is provided.

It should be particularly noted that, for the oxide Bi₂O₃—TiO₂—XO of the accessory ingredient, the oxide Bi₂O₃—TiO₂—XO is formed by mixing oxides Bi₂O₃, TiO₂, and XO, followed by sintering, and an addition ratio of the oxides Bi₂O₃, TiO₂, and XO may be expressed as αBi₂O₃+βTiO₂+γXO, where 0.15≦α≦0.80, 0.14≦β≦0.80, and 0≦γ≦0.7.

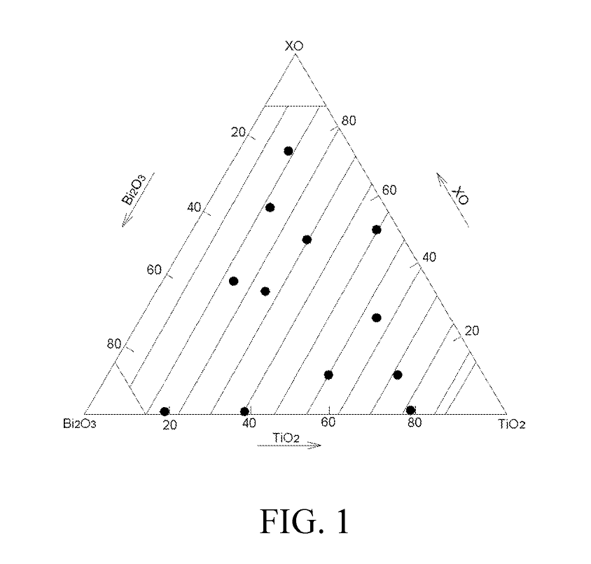

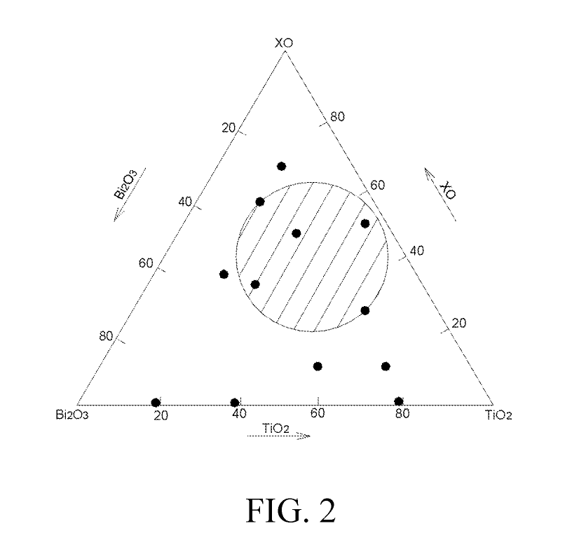

FIG. 1 is a ternary phase diagram of oxide Bi₂O₃—TiO₂—XO. FIG. 2 shows a formation area range of the oxide Bi₂O₃—TiO₂—XO meeting the X8S temperature range. It can be known from the ternary phase diagram of the oxide Bi₂O₃—TiO₂—XO of FIG. 1 that, the oxide Bi₂O₃—TiO₂—XO consists of oxides Bi₂O₃, TiO₂, and XO, and in a method for forming Bi₂O₃—TiO₂—XO, Bi₂O₃, TiO₂, and XO are mixed followed by milling and screening, and are finally calcined at 900° C., thereby forming the oxide Bi₂O₃—TiO₂—XO.

It can be known from the experimental results that, when the ingredients sintered in the particular area indicated in the ternary phase diagram, and the ceramic material sintered in the range as shown in FIG. 2 can meet the capacitance variation of X8S when being applied in a multi-layer ceramic capacitor element.

For example, Table 1 shows addition ratios of the oxides for forming the oxide Bi₂O₃—TiO₂—XO, and according to the ratios of 14 groups (A1 to A14) shown in Table 1, the accessory ingredient of the ceramic powder composition of the present invention, that is, the oxide Bi₂O₃—TiO₂—XO, is calcined first.

Then, the oxide Bi₂O₃—TiO₂—XO of the accessory ingredient and the main ingredient including BaTiO₃ are mixed and then sintered, and the sintering temperature is about 1200° C. to 1300° C. After sintering, a ceramic material is formed, which is applied in a multi-layer ceramic capacitor element.

In addition, Table 2 shows characteristics of the ceramic materials when the 14 groups (A1 to A14) shown in Table 1 and the main ingredient including BaTiO₃ are sintered at 1200° C. It can be known from Table 2 that, the characteristics of ceramic powder compositions of groups A3, A5, A6, A7, A10, and A13 meet the X8S specification.

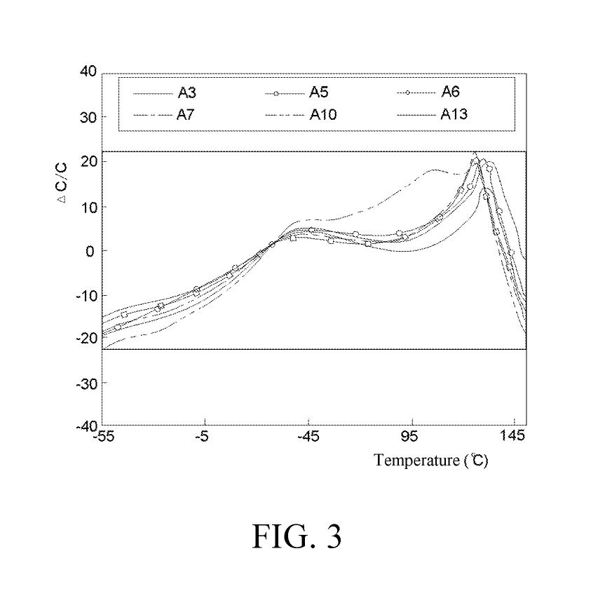

FIG. 3 is a relation diagram of capacitance variation of multi-layer ceramic capacitors and temperature. It can be known from FIG. 3 that, multi-layer ceramic capacitors of the groups A3, A5, A6, A7, A10, and A13 have a capacitance variation meeting the X8S temperature range, that is, has a relative capacitance variation of ±22% over a temperature range of −55° C. to 150° C.

TABLE 1
Addition ratios of oxides for forming oxide Bi2O3—TiO2—XO

| Sample | αBi₂O₃ + βTiO₂ + γXO | | | |
|---|---|---|---|---|
| No. | A | B | γ | X |
| A1 | 0.800 | 0.200 | 0 | Mn |
| A2 | 0.727 | 0.182 | 0.091 | Mn |
| A3 | 0.571 | 0.143 | 0.286 | Mn |
| A4 | 0.545 | 0.364 | 0.091 | Mn |
| A5 | 0.300 | 0.200 | 0.500 | Mn |
| A6 | 0.160 | 0.240 | 0.600 | Mn |
| A7 | 0.250 | 0.375 | 0.375 | Mn |
| A8 | 0.400 | 0.600 | 0 | Mn |
| A9 | 0.200 | 0.800 | 0 | Mn |
| A10 | 0.450 | 0.050 | 0.500 | Mn |
| A11 | 0.150 | 0.150 | 0.700 | Mn |
| A12 | 0.150 | 0.400 | 0.550 | Mn |
| A13 | 0.300 | 0.200 | 0.500 | Mg |

TABLE 2
Characteristics of ceramic materials

| | Dielectric | | | | X8S |
|---|---|---|---|---|---|
| Sample | Constant | DF (%) | IR (G-ohm) | Db | Characteristics |
| A1 | 2003 | 14.50 | 0.093 | 5.26 | NG |
| A2 | 1964 | 11.97 | 0.053 | 5.3 | NG |
| A3 | 1745 | 6.41 | 0.23 | 5.31 | Good |
| A4 | 1899 | 8.29 | 0.19 | 5.27 | NG |
| A5 | 2252 | 1.00 | 102 | 5.55 | Good |
| A6 | 2291 | 1.34 | 127 | 5.62 | Good |
| A7 | 2588 | 4.31 | 4.19 | 5.37 | Good |
| A8 | 2196 | 16.14 | 0.174 | 5.29 | NG |
| A9 | 2461 | 5.98 | 0.276 | 5.36 | NG |
| A10 | 2320 | 1.12 | 90 | 5.60 | Good |
| A11 | 2282 | 0.09 | 101 | 5.42 | NG |
| A12 | 2334 | 1.30 | 5.20 | 5.38 | NG |
| A13 | 1878 | 4.17 | 22.6 | 5.63 | Good |

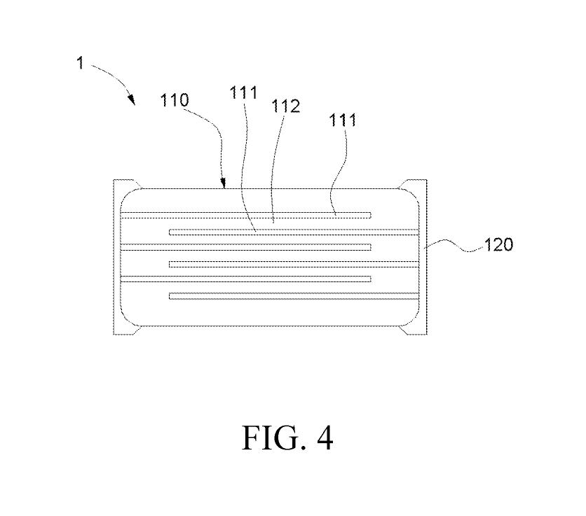

The ceramic powder composition of the present invention mainly can be applied in a multi-layer ceramic capacitor element. FIG. 4 is a sectional structural view of a multi-layer ceramic capacitor. Referring to FIG. 4, a multi-layer ceramic capacitor 1 includes a capacitor ceramic body 110 and an external electrode 120. The capacitor ceramic body 110 includes a plurality of dielectric ceramic layers 112 and a plurality of internal electrodes 111 formed along a surface of the dielectric ceramic layers. The external electrode 120 is formed out of the capacitor ceramic body 110, and is electrically connected to a part of the internal electrodes 111. The internal electrodes 111 may be nickel electrodes.

It should be particularly noted that, for the dielectric ceramic layers 112 of the multi-layer ceramic capacitor 1, the dielectric ceramic layers 112 are formed by sintering the ceramic powder composition of the present invention, and the sintering temperature is 1200 to 1300° C. After sintering, it can be known from the experimental results that, the multi-layer ceramic capacitor formed by the dielectric ceramic layers 112 formed by sintering the ceramic powder composition of the present invention has a capacitance variation meeting the X8S temperature range, that is, has a relative capacitance variation of ±22% over a temperature range of −55° C. to 150° C. Thus, a multi-layer ceramic capacitor meeting the X8S temperature range is provided.

In summary, by using a main ingredient including BaTiO₃ in combination with an accessory ingredient consisting of oxide Bi₂O₃—TiO₂—XO, the present invention provides a ceramic powder composition, a ceramic material, and a multi-layer ceramic capacitor fabricated thereby that meet the X8S temperature range.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ceramic powder composition, comprising:
a main ingredient, in an amount of 95 to 99 mol %, and comprising BaTiO₃; and
an accessory ingredient, in an amount of 1 to 5 mol %, and consisting of oxide Bi₂O₃—TiO₂—XO, wherein X is selected from a group consisting of magnesium (Mg), vanadium (V), manganese (Mn), and chromium (Cr).

2. The ceramic powder composition according to claim 1, wherein an addition ratio of oxides of the accessory ingredient for calcination is expressed as αBi₂O₃+βTiO₂+γXO, wherein 0.15≦α≦0.80, 0.14≦β≦0.80, and 0≦γ≦0.7.

3. A ceramic material, formed by sintering the ceramic powder composition according to claim 1.

4. The ceramic material according to claim 3, wherein a sintering temperature of the ceramic material is 1200 to 1300° C.

5. A multi-layer ceramic capacitor, comprising:
a ceramic dielectric, formed by sintering a main ingredient and an accessory ingredient, wherein the main ingredient is in an amount of 95 to 99 mol % and comprises BaTiO₃, and the accessory ingredient is in an amount of 1 to 5 mol % and consists of oxide Bi₂O₃—TiO₂—XO, wherein X is selected from a group consisting of magnesium (Mg), vanadium (V), manganese (Mn), and chromium (Cr);
a plurality of internal electrodes, extending in parallel in the ceramic dielectric; and
at least one external electrode, exposed out of the ceramic dielectric, and electrically connected to the internal electrodes.

6. The multi-layer ceramic capacitor according to claim 5, wherein the multi-layer ceramic capacitor has a capacitance variation meeting an X8S temperature range, that is, has a relative capacitance variation of lower than 22% over a temperature range of −55° C. to 150° C.

7. The multi-layer ceramic capacitor according to claim 5, wherein the internal electrodes are nickel electrodes.

8. The multi-layer ceramic capacitor according to claim 5, wherein an addition ratio of oxides of the accessory ingredient for calcination is expressed as αBi₂O₃+βTiO₂+γXO, wherein 0.15≦α≦0.80, 0.14≦β≦0.80, and 0≦γ≦0.7.

9. The multi-layer ceramic capacitor according to claim 5, wherein a sintering temperature of the ceramic dielectric is 1200 to 1300° C.
